(19) United States
(12) Patent Application Publication
(10) Pub. No.: US 2016/0355094 A1
(43) Pub. Date: Dec. 8, 2016

(54) POWER RECEIVING SYSTEM

(71) Applicant: EQUOS RESEARCH CO., LTD., Tokyo (JP)

(72) Inventors: Hiroyuki YAMAKAWA, Tokyo (JP); Kenichirou SATOU, Tokyo (JP)

(73) Assignee: EQUOS RESEARCH CO., LTD., Tokyo (JP)

(21) Appl. No.: 15/118,284

(22) PCT Filed: Mar. 23, 2015
(86) PCT No.: PCT/JP2015/058688

§ 371 Date: Aug. 11, 2016

(30) Foreign Application Priority Data
Mar. 26, 2014 (JP) 2014-063813

(51) Int. Cl. B60L 11/18; H02J 7/02; H02J 50/12

(52) U.S. Cl. CPC B60L 11/182; H02J 50/12; H02J 7/025

(57) ABSTRACT

A power receiving system that receives power supplied wirelessly to a power receiving circuit on a bottom portion of a vehicle via a magnetic field includes a power-receiving-side antenna coil unit including a power-receiving-side antenna coil and a first shield plate that is made of a magnetic material and arranged on a non-transmission direction side, and a second shield plate made of a magnetic material, the second shield plate having a shape that conforms to a recessed and protruding shape of a target region including a recessed portion of a vehicle body bottom surface of the vehicle and being arranged in the target region. The power-receiving-side antenna coil unit is arranged at a position overlapping with the recessed portion in a view in a direction along a reference axis.

### BACKGROUND

The present disclosure relates to a power receiving system for receiving power supplied wirelessly to a power receiving circuit provided on a bottom portion of a vehicle.

Electrical instruments and electrical apparatuses that can be moved without being fixed at one location, such as mobile telephones, personal information terminals (PDA), electrically-assisted bicycles, electric automobiles, or hybrid automobiles, have a power storage device such as a secondary battery provided internally. In many cases, charging of such a power storage device is performed by connecting a charging port provided in an instrument or apparatus and a power supply apparatus by cable or the like, for example. However, in recent years, a technique of supplying power wirelessly, that is, without contact, without using such a cable has been attracting attention. One technique of supplying power without contact is a technique in which magnetic field resonance is used. Magnetic field resonance is a technique in which a pair of resonance circuits having the same natural frequency (resonant frequency), such as a resonance circuit in power supply equipment and a resonance circuit in a device or apparatus, are caused to resonate via a magnetic field and power is transmitted via the magnetic field. JP 2009-106136A discloses a technique of supplying power without contact from a power source outside of a vehicle to a vehicle using this magnetic field resonance.

Incidentally, with power supply using magnetic field resonance, there are cases where electromagnetic noise is generated by a magnetic field generated around a coil unit that is included in the resonance circuit and includes a resonance coil (antenna coil) that is to serve as an antenna. For example, in some cases, electronic instruments and the like installed in the vehicle are influenced by the electromagnetic noise. Also, when a conductive body such as metal exists in the magnetic field, there is a possibility that the conductive body will heat up. For example, if the coil unit is installed on the bottom portion of the vehicle, metal components in the bottom portion of the vehicle will heat up in some cases. For this reason, it is preferable to sufficiently obtain a magnetic flux that forms a magnetic field for coupling the power-supply-side resonance circuit and the power-receiving-side resonance circuit, and to reduce magnetic flux that is not needed for coupling the resonance circuits such that as little leakage as possible occurs.

There is a method of providing a shield member in order to block this kind of magnetic flux, but if consideration is given to installation space and cost, it is preferable that such a shield member is as small in size as possible. For example, it is possible to achieve a smaller size by including a shield member on the side opposite to the power transmission direction in the vicinity of the antenna coil so as to form a coil unit. However, the power-supply antenna coil and the power receiving antenna coil do not necessarily oppose each other at the position with the best transmission efficiency (prescribed position). If the power-supply-side antenna coil and the power-receiving-side antenna coil oppose each other while being misaligned from this prescribed position, electromagnetic waves (magnetic flux) emitted from the power-supply-side antenna coil are not blocked by the power-receiving-side shield member, and there is a possibility that leakage will occur on the rear surface side (side opposite to transmission direction) of the power-receiving-side antenna coil. For this reason, it is conceivable to provide another shield member on the bottom portion of the vehicle as well, for example, on the rear surface side of the power-receiving-side antenna coil. However, if the distance between the shield member of the coil unit and the shield member of the vehicle is short, there is a possibility that an interfering current that flows in the direction of hindering the current that is generated during power transmission will be generated in the shield member of the vehicle and the power transmission efficiency will decrease (Lenz's law). Accordingly, when a shield member is provided in a vehicle, it is preferable to install the shield member such that a decrease in the transmission efficiency can be suppressed.

### SUMMARY

In view of the above-described background, a technique according to which a decrease in power transmission efficiency can be suppressed and electromagnetic waves that leak to the vehicle body can be effectively blocked is desired.

As one exemplary aspect, the above-described power receiving system is a power receiving system that receives power supplied wirelessly to a power receiving circuit provided on a bottom portion of a vehicle, the power receiving system including: a power-receiving-side antenna coil unit including: a power-receiving-side antenna coil, which is a coil formed by wrapping a conductive wire around a reference axis, the power-receiving-side antenna coil being provided in the power receiving circuit and being configured to receive power transmitted via a magnetic field, and a first shield member made of a magnetic material, the first shield member being arranged along a radial direction of the power-receiving-side antenna coil on a non-transmission direction side, which is a side opposite to a transmission direction side and which is one side along the reference axis, of the power-receiving-side antenna coil; and a second shield member made of a conductive material, the second shield member having a shape conforming to a recessed and protruding shape of a target region including a recessed portion that is recessed upward of a vehicle body bottom surface of the vehicle and being arranged in the target region, wherein the power-receiving-side antenna coil unit is arranged at a position overlapping with the recessed portion in a view in a direction along the reference axis.

With this configuration, the second shield member made of the conductive material is installed in the target region including the recessed portion that is recessed upward (ride space side) of the vehicle bottom surface. In other words, on the vehicle bottom surface, the second shield member is installed on a relatively upward side. Accordingly, it is easy to provide a gap between the power-receiving-side antenna coil unit, which is installed on the bottom portion of the vehicle, and the second shield member. Also, because the first shield member is included in the power-receiving-side antenna coil unit, it is easy to provide a gap between the second shield member and the first shield member as well. As a result, it is possible to suppress a case in which the interfering current that flows in the direction of hindering the current that is generated during power transmission is generated in the second shield member, and a decrease in the power transmission efficiency can be suppressed. Also, because the influence on the power transmission efficiency can be reduced, it is possible to set the size of the second shield member with consideration given to relative position misalignment with the power-supply-side antenna coil as well, and it is possible to attach the second shield member to the vehicle. Thus, with the present configuration, it is possible to suppress a decrease in the power transmission efficiency and to effectively block electromagnetic waves that leak to the vehicle body.

The magnetic flux that causes the current that flows in the direction of hindering the current generated during power transmission to be generated in the second shield member is a magnetic flux that interlinks with the power-receiving-side antenna coil. Accordingly, it is preferable to install the power-receiving-side antenna coil within the recessed portion, in which it is easy to provide a gap between the second shield member and the power-receiving-side antenna coil unit including the power-receiving-side antenna coil. As one aspect, with the power receiving system, it is preferable that in a view in a direction along the reference axis, the recessed portion is larger than an outer shape of the power-receiving-side antenna coil.

The first shield member is provided so as to suppress a case in which the magnetic flux that interlinks with the power-receiving-side antenna coil influences the vehicle side. Also, the amount of interfering current that is generated in the second shield member and flows in the direction of hindering the current that is generated during power transmission decreases the greater the distance between the first shield member and the second shield member. Accordingly, it is preferable to install the power-receiving-side antenna coil unit within the recessed portion, in which it is easy to provide a gap between the second shield member and the power-receiving-side antenna coil unit including the first shield member. As one aspect, with the power receiving system, it is preferable that in a view in a direction along the reference axis, the recessed portion is larger than an outer shape of the power-receiving-side antenna coil unit.

Since the power-receiving-side antenna coil unit is provided on the bottom portion of the vehicle, it is preferable that the power-receiving-side antenna coil unit is attached such that contact with an obstacle on the ground is reduced. That is, in the state in which the power-receiving-side antenna coil unit is attached to the vehicle as well, it is preferable that the lowest above-ground height set for the vehicle can be obtained. As one aspect, it is preferable that the power-receiving-side antenna coil unit is attached to the vehicle such that a site that is at a lowest position when attached to the vehicle is at a higher position than the lowest portion of the bottom portion of the vehicle.

### BRIEF DESCRIPTION OF THE DRAWINGS

FIG. 1 is a block diagram schematically showing a configuration of a wireless power supply system.

FIG. 2 is an equivalent circuit diagram of a resonance circuit.

FIG. 3 is a plan view schematically showing a configuration of an antenna coil.

FIG. 4 is a side view schematically showing a configuration of an antenna coil unit.

FIG. 5 is an enlarged side view schematically showing a configuration of a wireless power supply system.

FIG. 6 is a schematic plan view of an antenna coil unit when viewed from a bottom surface side of a vehicle.

### DETAILED DESCRIPTION OF EMBODIMENTS

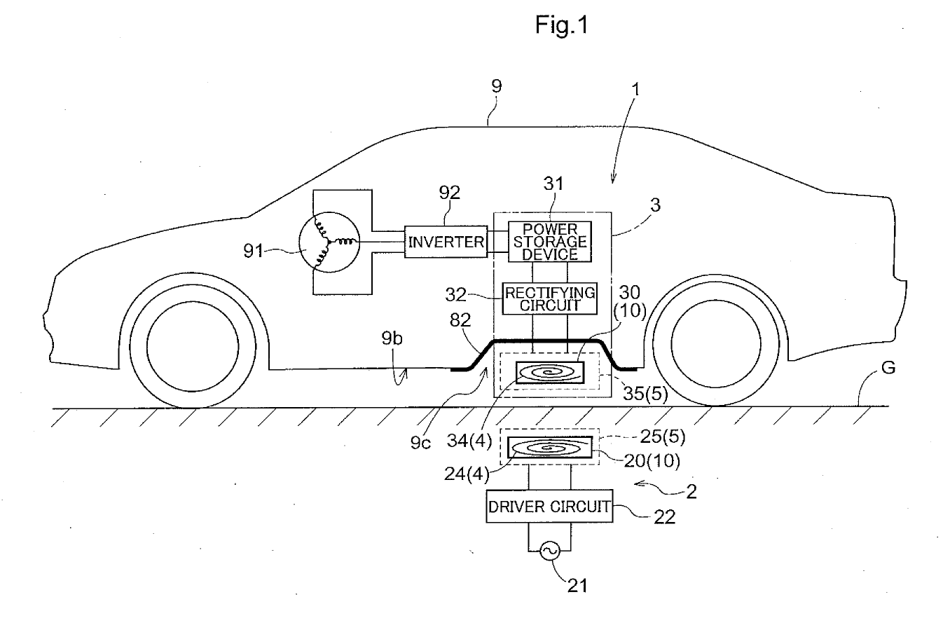

Hereinafter, embodiments of the present disclosure will be described taking, as an example, a wireless power supply system (power transmission system) that performs wireless power supply (wireless power transmission) to a vehicle using electromagnetic field resonance coupling (hereinafter abbreviated as “magnetic field resonance” where appropriate), with reference to the drawings. As shown in FIG. 1, the wireless power supply system 1 is constituted by a power supply system 2 installed in a power supply facility, and a power receiving system 3 mounted on the vehicle 9 side. In the present embodiment, in the case of using an outdoor facility, for example, the power supply system 2 is installed in the vicinity of a ground surface G, and in the case of using an indoor facility, the power supply system 2 is installed in the vicinity of a floor surface. The power receiving system 3 receives power supplied wirelessly from the power supply system 2, in a power receiving circuit (e.g., a later-described power-receiving-side resonance circuit 35) provided on a bottom portion of the vehicle 9.

As shown in FIG. 1, the power supply system 2 is constituted by including an AC power source 21, a driver circuit 22, and a power-supply-side resonance circuit 25 (power supply circuit). The power-supply-side resonance circuit 25 is constituted by including a power-supply-side resonance coil 24 (power-supply-side antenna coil). The power receiving system 3 is constituted by including a power-receiving-side resonance circuit 35 (power receiving circuit), a rectifying circuit 32, and a power storage device 31. The power-receiving-side resonance circuit 35 is constituted by including a power-receiving-side resonance coil 34 (power-receiving-side antenna coil). The power-supply-side resonance circuit 25 and the power-receiving-side resonance circuit 35 are resonance circuits having the same natural frequency (resonant frequency) and are both collectively referred to as resonance circuits 5. Also, the power-supply-side resonance coil 24 and the power-receiving-side resonance coil 34 are collectively referred to as resonance coils or antenna coils 4.

The antenna coil 4 is a coil that is formed by winding a conductive wire 40 around a reference axis X (X2, X3), although detailed description thereof will be given later with reference to FIGS. 3 to 5. The power-supply-side resonance coil 24 (power-supply-side antenna coil) provided in the power-supply-side resonance circuit 25 (power supply circuit) is formed by winding the conductive wire 40 around the reference axis “X2”, and transmits power via a magnetic field. The power-receiving-side resonance coil 34 (power-receiving-side antenna coil) provided in the power-receiving-side resonance circuit 35 (power receiving circuit) is formed by winding the conductive wire 40 around the reference axis “X3”, and receives power transmitted via a magnetic field.

The AC power source 21 of the power supply system 2 is, for example, a power source (system power source) supplied from a commercial distribution network owned by a power company, and the frequency thereof is 50 Hz or 60 Hz, for example. The driver circuit 22 is a circuit that converts the frequency of the 50-Hz or 60-Hz system power source into the resonant frequency of the power-supply-side resonance circuit 25 (resonance circuit 5) and is constituted by a high-frequency power source circuit.

The power storage device 31 of the power receiving system 3 is a DC power source capable of being electrically charged and discharged, and for example, a secondary battery such as a lithium-ion or nickel-hydrogen battery or a capacitor is used thereas. On the other hand, the power received by the power-receiving-side resonance circuit 35 is AC power having the resonant frequency of the power-receiving-side resonance circuit 35. The rectifying circuit 32 rectifies the AC power having the resonant frequency into DC power. Note that a circuit including both the driver circuit 22 and the power-supply-side resonance circuit 25, or the entire power supply system 2 is comparable to a power supply circuit in the broadest sense. Also, the power-supply-side resonance circuit 25 is comparable to a power supply circuit in a more limited sense. Similarly, the circuit including both the power-receiving-side resonance circuit 35 and the rectifying circuit, or the entire power receiving system 3 is comparable to a power receiving circuit in the broadest sense. Also, the power-receiving-side resonance circuit 35 is comparable to a power receiving circuit in a more limited sense.

For example, the vehicle 9 is an electric automobile driven by a rotating electrical machine 91, or a hybrid automobile driven by an internal combustion engine (not shown) and the rotating electrical machine 91. The rotating electrical machine 91 is connected to the power storage device 31 via an inverter 92 or other driver for a rotating electrical machine, for example. In the present embodiment, the rotating electrical machine 91 is a three-phase AC rotating electrical machine, for example, and the driver for the rotating electrical machine is configured to have the inverter 92 for converting to/from DC and AC as a core. The rotating electrical machine 91 can function as an electric motor and as a power generator.

The wireless power supply system 1 is a system for causing the pair of resonance circuits 5 (25, 35) to resonate via a magnetic field, and supplying power via the magnetic field. Note that magnetic resonance imaging (MRI), which is frequently used in the medical field, is known as a “resonance” technique that uses “magnetic properties”. However, in contrast to MRI using the physical phenomenon known as “magnetic spin resonance”, with the “magnetic resonance power supply apparatus” of the present embodiment, such a physical phenomenon is not used, and as described above, two resonance circuits 5 are caused to resonate via a magnetic field. Accordingly, here, the transmission method of the wireless power supply system 1 that transmits the power using resonance in a magnetic field is referred to as “electromagnetic field resonance coupling” or “magnetic field resonance”, taking into account its clear distinction from MRI. Also, this transmission method also differs from “electromagnetic induction”.

As described above, the power-supply-side resonance circuit 25 and the power-receiving-side resonance circuit 35 are circuits that have the same resonant frequency. For example, similarly to how when one of two tuning forks arranged apart from each other is vibrated in the air, the other tuning fork also vibrates due to resonating with the vibration transmitted via the air, the power-supply-side resonance circuit 25 and the power-receiving-side resonance circuit 35 also resonate. More specifically, the power-receiving-side resonance circuit 35 also resonates (electromagnetically vibrates) with electromagnetic vibration transmitted to the power-receiving-side resonance circuit 35 via a magnetic field generated due to the resonance (electromagnetic vibration) of the power-supply-side resonance circuit 25.

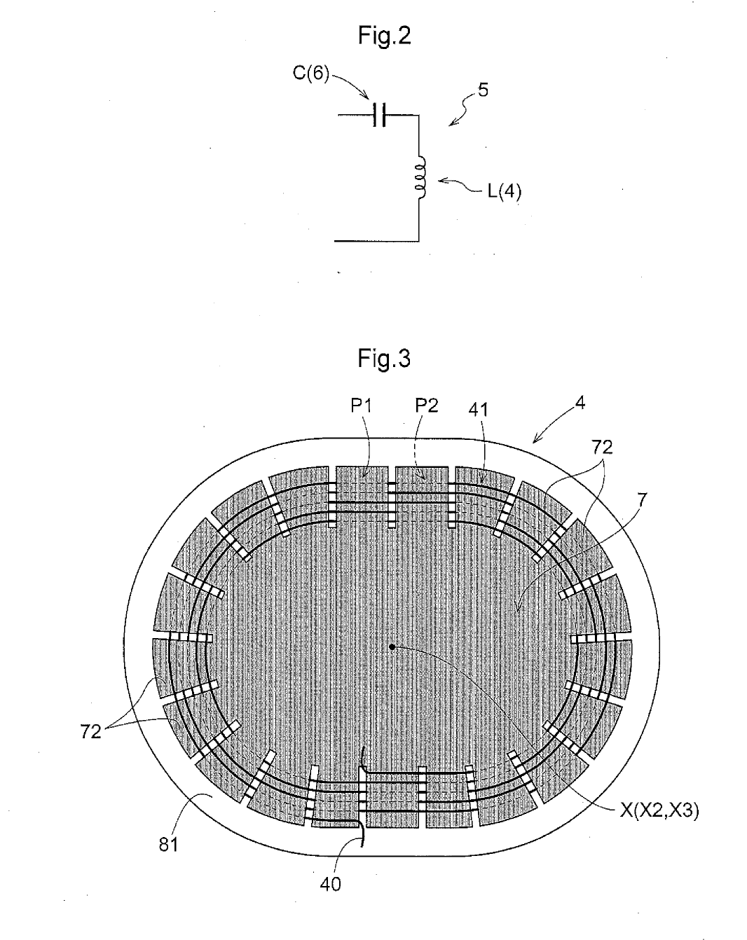

As one preferred mode, the power-supply-side resonance circuit 25 and the power-receiving-side resonance circuit 35 are constituted by LC resonators. As indicated by the equivalent circuit in FIG. 2, for example, the resonance circuits 5 are configured to have antenna coils 4 having inductance components “L” and capacitors 6 having capacitance components “C”.

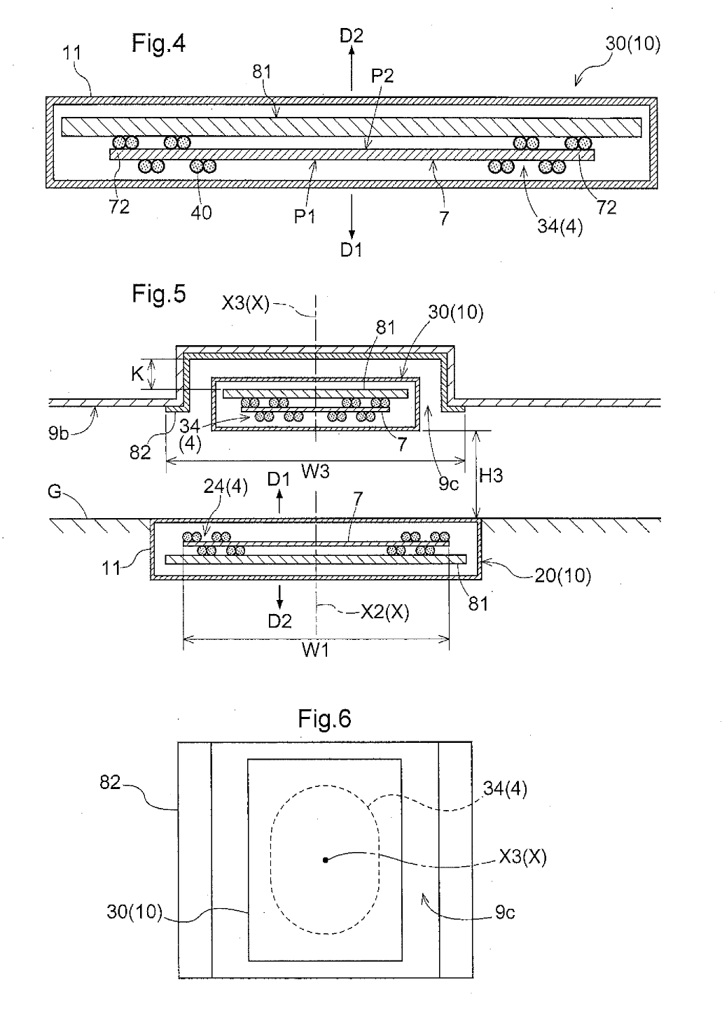

Incidentally, it is preferable that when performing wireless power supply from a power supply circuit to a power receiving circuit via a magnetic field, the wireless power supply system 1 can suppress leakage of electromagnetic waves to space other than the space needed for power transmission, and can perform power transmission with high efficiency. For this reason, in the present embodiment, an antenna coil unit 10 is configured to include the antenna coil 4, and a first shield plate 81 (first shield member) made of a magnetic material, as shown in FIGS. 3 and 4.

In the present embodiment, as shown schematically in FIG. 3, the power transmission antenna coil 4, which performs wireless power supply from a power supply circuit to a power receiving circuit, is mainly constituted by a coil 41 obtained by wrapping a conductive wire 40 in the form of a flat coil in an antenna frame 7, which includes multiple (here, an odd number) radial arms 72. The antenna frame 7 has a low dissipation factor (tan δ) and is constituted by a material with low permittivity, such as polypropylene, polycarbonate, or polyethylene. Also, the antenna frame 7 has a transmission surface P1, which is on one side of a radiation plane conforming to the radiation direction of the arms 72, and an inverse transmission surface P2, which is on the side opposite to the transmission surface P1. In the present embodiment, the conductive wire 40 is wrapped around so as to pass alternatingly through the transmission surface P1 side and the inverse transmission surface P2 side every two arms 72.

As shown in FIGS. 3 and 4, the antenna coil 4 is configured to include a first shield plate 81 that is made of a magnetic material, and is arranged along the radiation plane of the antenna frame 70 on the inverse transmission surface P2. Here, the magnetic material is a material having a property of a so-called strong magnetic body, and is a soft magnetic material. For example, ferrite, iron, silicon steel, and the like correspond to the magnetic material. The first shield plate 81 mainly functions as a magnetic shield that blocks the magnetic field.

As described above, it is preferable that when performing wireless power supply from a power supply circuit to a power receiving circuit via a magnetic field, the wireless power supply system 1 can suppress leakage of electromagnetic waves to a space other than the space needed for power transmission, and can perform power transmission with high efficiency. In particular, a configuration is preferable in which a decrease in power transmission efficiency can be suppressed and electromagnetic waves that leak to the vehicle body can be effectively blocked during power transmission to the vehicle 9. For this reason, as shown in FIGS. 4 and 5, in the power-receiving-side resonance coil 34 (power-receiving-side antenna coil), on a non-transmission direction D2 side, which is the side opposite to the transmission direction D1 side, which is one direction along a reference axis “X3” of the coil, the first shield plate 81 made of the magnetic material is arranged along the radial direction of the power-receiving-side resonance coil 34 (power-receiving-side antenna coil).

The vehicle 9 is on the transmission direction D1 side of the power-supply-side resonance coil 24 (power-supply-side antenna coil), as shown in FIG. 5. Also, in many cases, the power-supply-side resonance coil 24 (power supply system 2) is arranged in the vicinity of the ground surface G or in the vicinity of the floor surface. For this reason, the first shield plate 81 for suppressing unnecessary electromagnetic waves with respect to the vehicle 9 need not be included in the power-supply-side resonance coil 24. However, there are also cases where electric equipment or electronic apparatuses other than the power supply system 2 are installed in the vicinity of the ground surface G or in the vicinity of the floor surface. In order to suppress the influence on the electric equipment or electronic apparatuses, it is preferable to include the first shield plate 81 on the power-supply-side resonance coil 24 as well. The present embodiment illustrates a mode in which the first shield plate 81 is included on the power-supply-side resonance coil 24 as well. Specifically, on the side (the non-transmission direction D2 side) that is opposite to the one side (the transmission direction D1 side) along the reference axis “X2” of the power-supply-side resonance coil 24, the first shield plate 81 made of the magnetic material is arranged along the radial direction of the power-supply-side resonance coil 24 (power-supply-side antenna coil).

As shown in FIG. 4, the antenna coil unit 10 is configured to contain the antenna coil 4 and the first shield plate 81 made of the magnetic material in a housing 11. More specifically, as shown in FIG. 4, the power-receiving-side antenna coil unit 30 is configured to contain the power-receiving-side resonance coil 34 (power-receiving-side antenna coil) and the first shield plate 81 made of the magnetic material in the housing 11. Also, as shown in FIG. 5 for example, the power-supply-side antenna coil unit 20 is configured to contain the power-supply-side resonance coil 24 (power-supply-side antenna coil) and the first shield plate 81 made of the magnetic material in the housing 11.

As described above, a first shield plate 81 made of the magnetic material is included in each of the antenna coil units 10. In the present embodiment, as shown in FIGS. 1 and 5, a second shield plate 82 (second shield member) made of a conductive material is furthermore included on the vehicle 9 side, thus forming a power-receiving-side antenna coil unit 30 along with a power receiving system 3. Here, the conductive material is a material with a relatively small electrical resistance, and corresponds to aluminum, steel, or the like, for example. In other words, the second shield plate 82 is constituted by a material with a smaller specific resistance than iron, for example, or by a conductive material with a smaller specific resistance than a material of a member on the bottom surface of a vehicle body. The second shield plate 82 functions as an electromagnetic shield for blocking both an electric field and a magnetic field. In other words, the second shield plate 82 is included in the vehicle in order to further suppress the influence of electromagnetic waves on the vehicle 9.

Note that when the distance between the first shield plate 81 of the power-receiving-side antenna coil unit 30 and the second shield plate 82 of the vehicle 9 is short, a current (interfering current) that flows in the direction of hindering the current that is generated during power transmission is generated in the second shield plate 82 (Lenz's law). Accordingly, there is a possibility that a portion of the magnetic flux that interlinks with the power-receiving-side resonance coil 34 will be canceled out and the power transmission efficiency will decrease.

Accordingly, it is preferable that when the second shield plate 82 is installed in the vehicle 9, the second shield plate 82 is installed such that a decrease in the transmission efficiency can be suppressed. As will be described below, the power receiving system 3 according to the present disclosure is characterized by the installation of the second shield plate 82, the positional relationship between the second shield plate 82 and the power-receiving-side antenna coil unit 30, and the like.

FIG. 5 is an enlarged side view of a wireless power supply system, and FIG. 6 is a plan view of the power-receiving-side antenna coil unit 30 when viewed along the reference axis “X3” from a vehicle body bottom surface 9b side of the vehicle 9. As shown in FIG. 5, the second shield plate 82 has a shape that conforms to the recessed and protruding shape of the target region, which includes a recessed portion 9c that is recessed upward of the vehicle body bottom surface 9b of the vehicle 9. Also, the second shield plate 82 is arranged in the target region along the vehicle body bottom surface 9b. Also, as shown in FIG. 6, the power-receiving-side antenna coil unit 30 is arranged at a position that overlaps with the recessed portion 9c in a view in a direction along the reference axis “X3”. This recessed portion 9c is below the installation location of the transaxle, or the like, for example.

The second shield plate 82 made of the conductive material is arranged at a target region that includes the recessed portion 9c, which is recessed upward of the vehicle body bottom surface 9b, and therefore the second shield plate 82 is installed on the upper side in comparison to the average position of the vehicle body bottom surface 9b. Accordingly, it is easy to provide a gap between the power-receiving-side antenna coil unit 30 installed on the bottom portion of the vehicle 9 and the second shield plate 82. In other words, a gap of distance “K” can be ensured between the second shield plate 82 and the first shield plate 81 of the power-receiving-side antenna coil unit 30. It is preferable that “K” is about 5 to 10 [cm], for example.

If a suitable distance is thus provided between the second shield plate 82 and the first shield plate 81 of the power-receiving-side antenna coil unit 30, it is possible to suppress a case in which the above-described interfering current is generated in the second shield plate 82. As a result, it is possible to suppress a decrease in the power transmission efficiency as well. Also, because the influence on the power transmission efficiency can be reduced, a second shield plate 82 having a size with some leeway, with consideration given to relative position misalignment with the antenna coil on the power supply side, can be attached to the vehicle 9. As a result, it is possible to suppress a decrease in the power transmission efficiency and to effectively block electromagnetic waves that leak to the vehicle body.

Incidentally, the magnetic flux that generates the interfering current in the second shield plate 82 is a magnetic flux that interlinks with the power-receiving-side resonance coil 34 (power-receiving-side antenna coil). Accordingly, it is preferable to be able to install a power-receiving-side resonance coil 34 within the recessed portion 9c, in which it is easy to provide a gap between the power-receiving-side antenna coil unit 30 including the coil and the second shield plate 82. Specifically, as shown in FIG. 6, it is preferable that in a view in a direction along the reference axis “X3”, the recessed portion 9c is larger than the external shape of the power-receiving-side resonance coil 34. Alternatively, it is preferable that the external shape of the power-receiving-side resonance coil 34 is smaller than the recessed portion 9c in a direction along the reference axis “X3”,

As described above, the first shield plate 81 is provided so as to suppress a case in which the magnetic flux that interlinks with the power-receiving-side resonance coil 34 influences the vehicle 9 side. Also, the amount of interfering current that is generated in the second shield plate 82 decreases as the distance between the first shield plate 81 and the second shield plate 82 increases, Accordingly, it is preferable to be able to install the power-receiving-side antenna coil unit 30 within the recessed portion 9c, in which it is easy to provide a gap between the second shield plate 82 and the power-receiving-side antenna coil unit 30 that includes the first shield plate 81. Specifically, as shown in FIG. 6, it is further preferable that in a view in a direction along the reference axis “X3”, the external shape of the power-receiving-side antenna coil unit 30 is larger than the recessed portion 9c.

Note that from the viewpoint of suppressing a case in which the magnetic flux from the power-supply-side resonance coil 24 (power-supply-side antenna coil) of the power-supply-side antenna coil unit 20 interlinks with the vehicle body bottom surface 9b of the vehicle 9, it is preferable that in a view in a direction along the reference axis X (X2), the second shield plate 82 is larger than the outer shape of the power-supply-side resonance coil 24 (power-supply-side antenna coil). More specifically, it is preferable that the second shield plate 82 is larger than the outer radius of the power-supply-side antenna coil unit 20 in a view in a direction along the reference axis X (X2). For example, as shown in cross-sectional view in FIG. 5, it is preferable that an installation range “W3” for the second shield plate 82 is larger than an outer shape width “W1” of the power-supply-side resonance coil 24 (power-supply-side antenna coil).

Incidentally, the power-receiving-side antenna coil unit 30 is provided on the bottom surface of the vehicle 9, and therefore it is preferable that the power-receiving-side antenna coil unit 30 is attached such that contact with an obstacle on the ground is reduced. In other words, in the state in which the power-receiving-side antenna coil unit is attached to the vehicle as well, it is preferable that the lowest above-ground height set for the vehicle 9 can be ensured. For example, it is preferable that the power-receiving-side antenna coil unit 30 is attached to the vehicle 9 such that the site that is at the lowest position in the state of being attached to the vehicle 9 is at a position that is higher than the lowest portion of the bottom portion of the vehicle 9, although this is not shown in the drawings. Here, when the power-receiving-side antenna coil unit 30 is attached to the vehicle 9, the height from the ground surface G to the site that is at the lowest position in the power-receiving-side antenna coil unit 30 is set to “H3” (lowest above-ground height after unit installation). It is preferable that the power-receiving-side antenna coil unit 30 is attached to the vehicle 9 such that the lowest above-ground height H3 after unit installation is higher than the height (lowest above-ground height) of the lowest portion of the bottom portion of the vehicle 9.

Naturally, the power-receiving-side antenna coil unit 30 need not be attached to the vehicle 9 such that the lowest above-ground height H3 after unit installation is higher than the lowest above-ground height of the vehicle 9. For example, the “lowest above-ground height H3 after unit installation” and the “lowest above-ground height” may be the same. In a case in which installing the power-receiving-side antenna coil unit 30 at a position lower than the lowest above-ground height causes few problems in the relationship between the approach angle and departure angle and the lowest above-ground height, and in the relationship with a position and the like at which it is easy to come into contact with an obstacle when going over an obstacle, the lowest above-ground height H3 after unit installation may be lower than the lowest above-ground height.

### Other Embodiments

Hereinafter, other embodiments will be described. Note that the configurations of the embodiments described below are not limited to being applied individually and may be applied in combination with configurations of other embodiments, as long as there are no discrepancies.

(1) In the description above, a description was given taking, as an example, a wireless power supply system 1 (power transmission system) that performs wireless power supply to a vehicle using electromagnetic resonance coupling (magnetic field resonance). However, the transmission method is not limited to this method, and for example, an electromagnetic induction method may be used as well.

(2) In the description above, a mode was described in which, in a view along the reference axis “X3”, the recessed portion 9c is larger than the outer shape of the power-receiving-side resonance coil 34 (power-receiving-side antenna coil), or the outer shape of the power-receiving-side antenna coil unit 30. However, the present disclosure is not limited to these modes. For example, the generation amount of interfering current can be reduced also in a mode in which the recessed portion 9c is smaller than these outer shape and a partial gap is formed between the first shield plate 81 and the second shield plate 82.

### INDUSTRIAL APPLICABILITY

The present disclosure can be used in a power receiving system that receives power supplied wirelessly to a power receiving circuit provided on a bottom portion of a vehicle.

1. A power receiving system that receives power supplied wirelessly to a power receiving circuit provided on a bottom portion of a vehicle, the power receiving system comprising:
a power-receiving-side antenna coil unit including:
a power-receiving-side antenna coil, which is a coil formed by wrapping a conductive wire around a reference axis, the power-receiving-side antenna coil being provided in the power receiving circuit, and being configured to receive power transmitted via a magnetic field, and
a first shield member made of a magnetic material, the first shield member being arranged along a radial direction of the power-receiving-side antenna coil on a non-transmission direction side, which is a side opposite to a transmission direction side and which is one side along the reference axis, of the power-receiving-side antenna coil; and
a second shield member made of a conductive material, the second shield member having a shape conforming to a recessed and protruding shape of a target region including a recessed portion that is recessed upward of a vehicle body bottom surface of the vehicle and being arranged in the target region,
wherein the power-receiving-side antenna coil unit is arranged at a position overlapping with the recessed portion in a view in a direction along the reference axis.

2. The power receiving system according to claim 1, wherein in the view in the direction along the reference axis, the recessed portion is larger than an outer shape of the power-receiving-side antenna coil.

3. The power receiving system according to claim 1, wherein in the view in the direction along the reference axis, the recessed portion is larger than an outer shape of the power-receiving-side antenna coil unit.

4. The power receiving system according to claim 1, wherein the power-receiving-side antenna coil unit is attached to the vehicle such that a lowest position of the power-receiving-side antenna coil unit is higher than a lowest position of the bottom portion of the vehicle.

5. The power receiving system according to claim 2, wherein the power-receiving-side antenna coil unit is attached to the vehicle such that a lowest position of the power-receiving-side antenna coil unit is higher than a lowest position of the bottom portion of the vehicle.

6. The power receiving system according to claim 3, wherein the power-receiving-side antenna coil unit is attached to the vehicle such that a lowest position of the power-receiving-side antenna coil unit is higher than a lowest position of the bottom portion of the vehicle.
